(19) United States
(12) Patent Application Publication
(10) Pub. No.: US 2026/0197927 A1
(43) Pub. Date: Jul. 9, 2026

(54) A DROPLET STREAM ALIGNMENT MECHANISM AND METHOD THEREOF

(71) Applicant: ASML Netherlands B.V., Veldhoven (NL)

(72) Inventors: Wyatt DUVALL, San Diego, CA (US); Guy du Motay VEBER, San Marcos, CA (US); Ethan Marcus SWERDLOW, San Diego, CA (US)

(73) Assignee: ASML Netherlands B.V., Veldhoven (NL)

(21) Appl. No.: 19/128,783

(22) PCT Filed: Nov. 7, 2023
(86) PCT No.: PCT/EP2023/081067

§ 371 Date: May 9, 2025

Related U.S. Application Data
(60) Provisional application No. 63/384,071, filed on Nov. 16, 2022.

(51) Int. Cl. H05G 2/00

(52) U.S. Cl. CPC H05G 2/0027; H05G 2/0023; H05G 2/0035

(57) ABSTRACT

A system (600) includes first (604) and second (606) portions of an alignment mechanism. The first portion is coupled to a nozzle (602) within a droplet generation device. The second portion is coupled to an outside surface (608) of the droplet generation device. The second portion comprises a second adjustment mechanism (612) to adjust a first adjustment mechanism (610) of the first portion in order to align the nozzle such that droplets travel from the nozzle substantially along a droplet path (614).

### CROSS-REFERENCE TO RELATED APPLICATIONS

This application claims priority of U.S. application No. 63/384,071 which was filed on Nov. 16, 2022, and which is incorporated herein in its entirety by reference.

### TECHNICAL FIELD

The present application relates to extreme ultraviolet (“EUV”) radiation sources and methods thereof. In one exemplary application, EUV radiation may be used as exposure radiation in a lithographic process to fabricate semiconductor devices.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which may be a mask or a reticle, can be used to generate a circuit pattern to be formed on an individual layer of the IC. This pattern can be transferred onto a target portion (e.g., comprising part of, one, or several dies) on a substrate (e.g., a silicon wafer). Transfer of the pattern is typically via imaging onto a layer of radiation-sensitive material (photoresist or simply “resist”) provided on the substrate. In general, a single substrate will contain a network of adjacent target portions that are successively patterned. Known lithographic apparatuses include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the target portions parallel or anti-parallel to this scanning direction. It is also possible to transfer the pattern from the patterning device to the substrate by imprinting the pattern onto the substrate.

A lithographic apparatus typically includes an illumination system that conditions radiation generated by a radiation source before the radiation is incident upon a patterning device. A patterned beam of EUV light can be used to produce extremely small features on a substrate. Extreme ultraviolet light (also sometimes referred to as soft x-rays) is generally defined as electromagnetic radiation having wavelengths in the range of about 5-100 nm. One particular wavelength of interest for photolithography occurs at 13.5 nm.

Methods to produce EUV light include, but are not necessarily limited to, converting a source material into a plasma state that has a chemical element with an emission line in the EUV range. These elements can include, but are not necessarily limited to, xenon, lithium and tin.

In one such method, often termed laser produced plasma (“LPP”), the desired plasma can be produced by irradiating a source material, for example, in the form of a droplet, stream or wire, with a laser beam. In another method, often termed discharge produced plasma (“DPP”), the required plasma can be generated by positioning source material having an appropriate emission line between a pair of electrodes and causing an electrical discharge to occur between the electrodes.

One technique for generating droplets involves melting a target material such as tin and then forcing it under high pressure through a relatively small diameter orifice of a nozzle, such as an orifice having a diameter of about 0.5 μm to about 30 μm, to produce a stream of droplets having droplet velocities in the range of about 30 m/s to about 150 m/s. The material and design structure of the nozzle capillary may have associated uncertainties. Too large of an uncertainty may result in the droplets coming into contact with ancillary devices near the path of the droplet stream, resulting in contamination of the struck devices. Large uncertainties also lead to adverse impacts to EUV production, which in turn can impact accuracy of lithographic processes that depend on the EUV radiation.

### SUMMARY

Accordingly, it is desirable provide controls for adjusting the aim of droplet streams in-situ to ensure that the droplets come into contact with the laser to convert the droplets into a plasma that emits EUV radiation and is it similarly desirable to reduce instabilities in EUV generation to improve accuracy in EUV lithographic apparatuses.

In some embodiments, a system comprises first and second portions of an alignment mechanism. The first portion is coupled to a nozzle and disposed within a droplet generation device. The second portion is coupled to an outside surface of the droplet generation device. The second portion comprises a second adjustment mechanism to adjust a first adjustment mechanism of the first portion in order to align the nozzle such that droplets travel from the nozzle substantially along a droplet path. In some embodiments, the alignment mechanism is used to align components into place prior to installation. In some embodiments, the alignment mechanism is a steering mechanism to fine tune the positioning of the nozzle.

In some embodiments, a method comprises generating droplets from a nozzle of a droplet generation device. The nozzle is coupled to a first portion of an alignment mechanism. The method further comprises transmitting the droplets toward a target region. The method further comprises determining a position of the droplets with respect to the target region. The method further comprises adjusting, based on the determining, a position of the nozzle through an interaction of the first portion of the alignment mechanism and a second portion of the alignment mechanism, the second portion being coupled to an outer surface of the droplet generation device.

In some embodiments, a system comprises first and second portions of an alignment mechanism. The first portion is coupled to a nozzle within a droplet generation device. The first portion comprises a first adjustment mechanism. The second portion is coupled to an outside surface of the droplet generation device. The second portion comprises a second adjustment mechanism to adjust the first adjustment mechanism in order to align the nozzle, such that droplets travel from the nozzle substantially along a droplet path. The first adjustment mechanism comprises a cradle to hold the nozzle, at least one clamp to affix the nozzle to the cradle, and a spherical bearing. The spherical bearing comprises a spherical structure supported in a groove and a leaf spring to bias the spherical structure toward the groove. The second adjustment mechanism comprises a base rigidly coupled to the nozzle and a mounting plate coupled to a frame of the system. The mounting plate is to be disposed on the base. The second adjustment mechanism further comprises a pad rigidly coupled to the mounting plate and an intermediate structure rigidly coupled to base. The intermediate structure is to be coupled to the pad. The second adjustment mechanism further comprises locking devices to lock the base to the mounting plate.

Further features of various embodiments of the present disclosure are described in detail below with reference to the accompanying drawings. It is noted that the present disclosure is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 shows a reflective lithographic apparatus, according to some embodiments.

FIGS. 2A, 2B, and 3 show more details of a reflective lithographic apparatus, according to some embodiments.

FIG. 4 shows a lithographic cell, according to some embodiments.

FIG. 5 shows a source material delivery system, according to some embodiments.

FIGS. 6 and 7 show droplet generator apparatuses, according to some embodiments.

FIG. 8 shows an adjustment mechanism, according to some embodiments.

FIGS. 9A, 9B and 9C show a spherical bearing, according to some embodiments.

FIGS. 10, 11, 12A, and 12B show adjustment mechanisms, according to some embodiments.

FIG. 13 isa flow chart that shows operations for a method for adjusting a direction of a droplet stream, according to some embodiments.

FIG. 14A shows portions of a steering mechanism, according to some embodiments.

FIG. 14B shows a motorized embodiment of portions of a steering mechanism.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not necessarily be interpreted as to-scale drawings.

### DETAILED DESCRIPTION

This specification discloses one or more embodiments that incorporate the features of the present disclosure. The disclosed embodiment(s) are provided as examples. The scope of the present disclosure is not limited to the disclosed embodiment(s). Claimed features are defined by the claims appended hereto.

The embodiment(s) described, and references in the specification to “one embodiment,” “an embodiment,” “an exemplary embodiment,” “an example embodiment,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Spatially relative terms, such as “beneath,” “below,” “lower,” “above,” “on,” “upper” and the like, can be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus can be otherwise oriented (rotated 90 degrees or at other orientations) and the spatially relative descriptors used herein may likewise be interpreted accordingly.

The term “about” may be used herein indicates the value of a given quantity that can vary based on a particular technology. Based on the particular technology, the term “about” may indicate a value of a given quantity that varies within, for example, 10-30% of the value (e.g., ±10%, ±20%, or ±30% of the value).

Embodiments of the disclosure can be implemented in hardware, firmware, software, or any combination thereof. Embodiments of the disclosure may also be implemented as instructions stored on a non-transitory machine-readable medium, which can be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, and/or instructions can be described herein as performing certain actions. However, it should be appreciated that such descriptions are merely for convenience and that such actions in fact result from computing devices, processors, controllers, or other devices executing the firmware, software, routines, instructions, etc.

Before describing such embodiments in more detail, however, it is instructive to present an example environment in which embodiments of the present disclosure can be implemented.

### Example Lithographic Systems

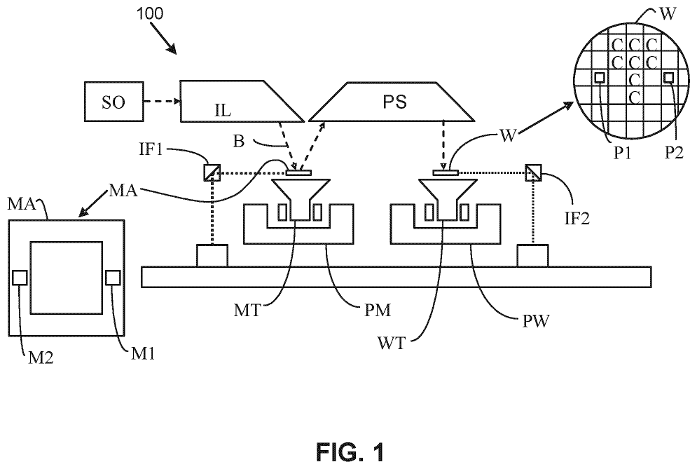

FIG. 1 shows a lithographic apparatus 100 in which embodiments of the present disclosure may be implemented. Lithographic apparatus 100 includes the following: an illumination system (illuminator) IL configured to condition a radiation beam B (for example, deep ultra violet or extreme ultra violet radiation); a support structure (for example, a mask table) MT configured to support a patterning device (for example, a mask, a reticle, or a dynamic patterning device) MA and connected to a first positioner PM configured to accurately position the patterning device MA; and, a substrate table (for example, a wafer table) WT configured to hold a substrate (for example, a resist coated wafer) W and connected to a second positioner PW configured to accurately position the substrate W. Lithographic apparatus 100 also has a projection system PS configured to project a pattern imparted to the radiation beam B by patterning device MA onto a target portion (for example, comprising one or more dies) C of the substrate W. In lithographic apparatus 100, the patterning device MA and the projection system PS are reflective.

The illumination system IL may include various types of optical components, such as refractive, reflective, catadioptric, magnetic, electromagnetic, electrostatic, or other types of optical components, or any combination thereof, for directing, shaping, or controlling the radiation beam B. The illumination system IL may also include a sensor ES that provides a measurement of, for example, one or more of energy per pulse, photon energy, intensity, average power, and the like. The illumination system IL may include a measurement sensor MS for measuring a movement of the radiation beam B and uniformity compensators UC that allow an illumination slit uniformity to be controlled. The measurement sensor MS may also be disposed at other locations. For example, the measurement sensor MS may be on or near the substrate table WT.

The support structure MT holds the patterning device MA in a manner that depends on the orientation of the patterning device MA with respect to a reference frame, the design of lithographic apparatus 100, and other conditions, such as whether or not the patterning device MA is held in a vacuum environment. The support structure MT may use mechanical, vacuum, electrostatic, or other clamping techniques to hold the patterning device MA. The support structure MT may be a frame or a table, for example, which may be fixed or movable, as required. By using sensors, the support structure MT may ensure that the patterning device MA is at a desired position, for example, with respect to the projection system PS.

The term “patterning device” MA should be broadly interpreted as referring to any device that may be used to impart a radiation beam B with a pattern in its cross-section, such as to create a pattern in the target portion C of the substrate W. The pattern imparted to the radiation beam B may correspond to a particular functional layer in a device being created in the target portion C to form an integrated circuit.

The patterning device MA may be reflective. Examples of patterning devices MA include reticles, masks, programmable mirror arrays, or programmable LCD panels. Masks are well known in lithography, and include mask types such as binary, alternating phase shift, or attenuated phase shift, as well as various hybrid mask types. An example of a programmable mirror array employs a matrix arrangement of small mirrors, each of which may be individually tilted so as to reflect an incoming radiation beam in different directions. The tilted mirrors impart a pattern in the radiation beam B, which is reflected by a matrix of small mirrors.

The term “projection system” PS may encompass any type of projection system, including refractive, reflective, catadioptric, magnetic, electromagnetic and electrostatic optical systems, or any combination thereof, as appropriate for the exposure radiation being used, or for other factors, such as the use of an immersion liquid on the substrate W or the use of a vacuum. A vacuum environment may be used for EUV or electron beam radiation since other gases may absorb too much radiation or electrons. A vacuum environment may therefore be provided to the whole beam path with the aid of a vacuum wall and vacuum pumps.

Lithographic apparatus 100 may be of a type having two (dual stage) or more substrate tables WT (and/or two or more mask tables). In such “multiple stage” machines, the additional substrate tables WT may be used in parallel, or preparatory steps may be carried out on one or more tables while one or more other substrate tables WT are being used for exposure. In some situations, the additional table may not be a substrate table WT.

The lithographic apparatus may also be of a type wherein at least a portion of the substrate may be covered by a liquid having a relatively high refractive index, e.g., water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

The illuminator IL receives a radiation beam from a radiation source SO. The source SO and the lithographic apparatus 100 may be separate physical entities, for example, when the source SO is an excimer laser. In such cases, the source SO is not considered to form part of the lithographic apparatus 100 and the radiation beam B passes from the source SO to the illuminator IL with the aid of a beam delivery system BD (not shown) including, for example, suitable directing mirrors and/or a beam expander. In other cases, the source SO may be an integral part of the lithographic apparatus 100, for example, when the source SO is a mercury lamp. The source SO and the illuminator IL, together with the beam delivery system BD, if required, may be referred to as a radiation system.

The illuminator IL may be used to condition the radiation beam B to have a desired uniformity and intensity distribution in its cross section. The desired uniformity of radiation beam B may be maintained by using a uniformity compensator. Uniformity compensator comprises a plurality of protrusions (e.g., fingers) that may be adjusted in the path of radiation beam B to control the uniformity of radiation beam B. A sensor may be used to monitor the uniformity of radiation beam B.

The radiation beam B is incident on the patterning device (for example, mask) MA, which is held on the support structure (for example, mask table) MT, and is patterned by the patterning device MA. In lithographic apparatus 100, the radiation beam B is reflected from the patterning device (for example, mask) MA. After being reflected from the patterning device (for example, mask) MA, the radiation beam B passes through the projection system PS, which focuses the radiation beam B onto a target portion C of the substrate W. With the aid of the second positioner PW and position sensor IF2 (for example, an interferometric device, linear encoder, or capacitive sensor), the substrate table WT may be moved accurately (for example, so as to position different target portions C in the path of the radiation beam B). Similarly, the first positioner PM and another position sensor IF1 may be used to accurately position the patterning device (for example, mask) MA with respect to the path of the radiation beam B. Patterning device (for example, mask) MA and substrate W may be aligned using mask alignment marks M1, M2 and substrate alignment marks P1, P2.

The lithographic apparatus 100 may be used in at least one of the following modes:
1. In step mode, the support structure (for example, mask table) MT and the substrate table WT are kept essentially stationary, while an entire pattern imparted to the radiation beam B is projected onto a target portion C at one time (i.e., a single static exposure). The substrate table WT is then shifted in the X and/or Y direction so that a different target portion C may be exposed.
2. In scan mode, the support structure (for example, mask table) MT and the substrate table WT are scanned synchronously while a pattern imparted to the radiation beam B is projected onto a target portion C (i.e., a single dynamic exposure). The velocity and direction of the substrate table WT relative to the support structure (for example, mask table) MT may be determined by the (de-) magnification and image reversal characteristics of the projection system PS.
3. In another mode, the support structure (for example, mask table) MT is kept substantially stationary holding a programmable patterning device, and the substrate table WT is moved or scanned while a pattern imparted to the radiation beam B is projected onto a target portion C. A pulsed radiation source SO may be employed and the programmable patterning device is updated as required after each movement of the substrate table WT or in between successive radiation pulses during a scan. This mode of operation may be readily applied to maskless lithography that utilizes a programmable patterning device, such as a programmable mirror array.

Combinations and/or variations on the described modes of use or entirely different modes of use may also be employed.

In a further embodiment, lithographic apparatus 100 includes EUV radiation source configured to generate a beam of EUV radiation for EUV lithography. In general, the EUV radiation source is configured in a radiation system, and a corresponding illumination system is configured to condition the EUV radiation beam of the EUV source.

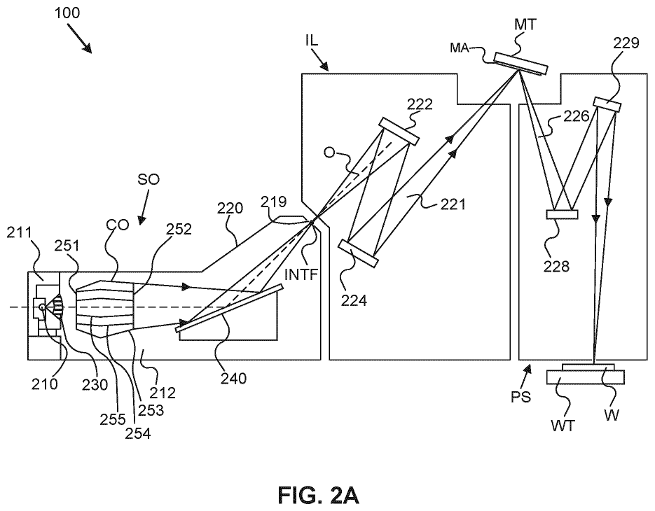

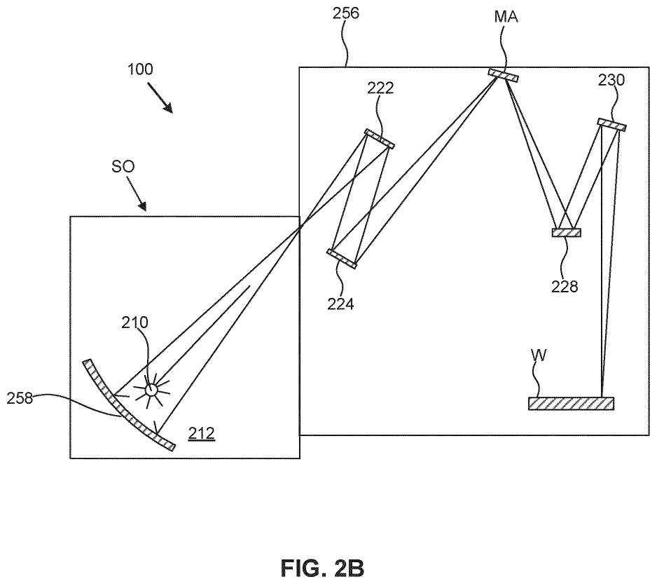

FIG. 2A shows the lithographic apparatus 100 (e.g., FIG. 1) in more detail, including the source collector apparatus SO, the illumination system IL, and the projection system PS, according to some embodiments. The source collector apparatus SO is constructed and arranged such that a vacuum environment may be maintained in an enclosing structure 220 of the source collector apparatus SO. An EUV radiation emitting plasma 210 may be formed by a discharge produced plasma source. In some embodiments, a plasma of excited tin (Sn) (e.g., excited via a laser) is provided to produce EUV radiation.

The radiation emitted by the EUV radiation emitting plasma 210 is passed from a source chamber 211 into a collector chamber 212 via an optional gas barrier or contaminant trap 230 (in some cases also referred to as contaminant barrier or foil trap), which is positioned in or behind an opening in source chamber 211. The contaminant trap 230 may include a channel structure. Contamination trap 230 may also include a gas barrier or a combination of a gas barrier and a channel structure. The contaminant trap or contaminant barrier 230 further indicated herein at least includes a channel structure.

The collector chamber 212 may include a radiation collector CO, which may be a so-called grazing incidence collector. Radiation collector CO has an upstream radiation collector side 251 and a downstream radiation collector side 252. Radiation that traverses collector CO may be reflected off a grating spectral filter 240 to be focused in a virtual source point INTF. The virtual source point INTF is commonly referred to as the intermediate focus, and the source collector apparatus is arranged such that the intermediate focus INTF is located at or near an opening 219 in the enclosing structure 220. The virtual source point INTF is an image of the EUV radiation emitting plasma 210. Grating spectral filter 240 is used in particular for suppressing infra-red (IR) radiation.

Subsequently the radiation traverses the illumination system IL, which may include a faceted field mirror device 222 and a faceted pupil mirror device 224 arranged to provide a desired angular distribution of the radiation beam 221, at the patterning device MA, as well as a desired uniformity of radiation intensity at the patterning device MA. Upon reflection of the beam of radiation 221 at the patterning device MA, held by the support structure MT, a patterned beam 226 is formed and the patterned beam 226 is imaged by the projection system PS via reflective elements 228, 229 onto a substrate W held by the wafer stage or substrate table WT. This is intended to be exemplary only, as other illumination systems utilize various other different mirrors and optical devices to direct radiation beam 221 to the patterning device MA.

More elements than shown may generally be present in illumination optics unit IL and projection system PS. The grating spectral filter 240 may optionally be present, depending upon the type of lithographic apparatus. Further, there may be more mirrors present than those shown in the FIG. 2A, for example there may be one to six additional reflective elements present in the projection system PS than shown in FIG. 2A.

In some embodiments, illumination optics unit IL may include a sensor ES that provides a measurement of, for example, one or more of energy per pulse, photon energy, intensity, average power, and the like. Illumination optics unit IL may include a measurement sensor MS for measuring a movement of the radiation beam B and uniformity compensators UC that allow an illumination slit uniformity to be controlled. The measurement sensor MS may also be disposed at other locations. For example, the measurement sensor MS may be on or near the substrate table WT.

Collector optic CO, as illustrated in FIG. 2A, is depicted as a nested collector with grazing incidence reflectors 253, 254, and 255, just as an example of a collector (or collector mirror). The grazing incidence reflectors 253, 254, and 255 are disposed axially symmetric around an optical axis O and a collector optic CO of this type is preferably used in combination with a discharge produced plasma source, often called a DPP source.

FIG. 2B shows selected portions of lithographic apparatus 100 (e.g., FIG. 1), but with alternative collection optics in the source collector apparatus SO, according to some embodiments. It should be appreciated that structures shown in FIG. 2A that do not appear in FIG. 2B (for drawing clarity) may still be included in embodiments referring to FIG. 2B. Elements in FIG. 2B having the same reference numbers as those in FIG. 2A have the same or substantially similar structures and functions as described in reference to FIG. 2A. In some embodiments, the lithographic apparatus 100 may be used, for example, to expose a substrate W such as a resist coated wafer with a patterned beam of EUV light. In FIG. 2B, the illumination system IL and the projection system PS are represented combined as an exposure device 256 (e.g., an integrated circuit lithography tool such as a stepper, scanner, step and scan system, direct write system, device using a contact and/or proximity mask, etc.) that uses EUV light from the source collector apparatus SO. The lithographic apparatus 100 may also include collector optic 258 that reflects EUV light from the EUV radiation emitting plasma 210 along a path into the exposure device 256 to irradiate the substrate W. Collector optic 258 may comprise a near-normal incidence collector mirror having a reflective surface in the form of a prolate spheroid (i.e., an ellipse rotated about its major axis) having, e.g., a graded multi-layer coating with alternating layers of Molybdenum and Silicon, and in some cases, one or more high temperature diffusion barrier layers, smoothing layers, capping layers and/or etch stop layers.

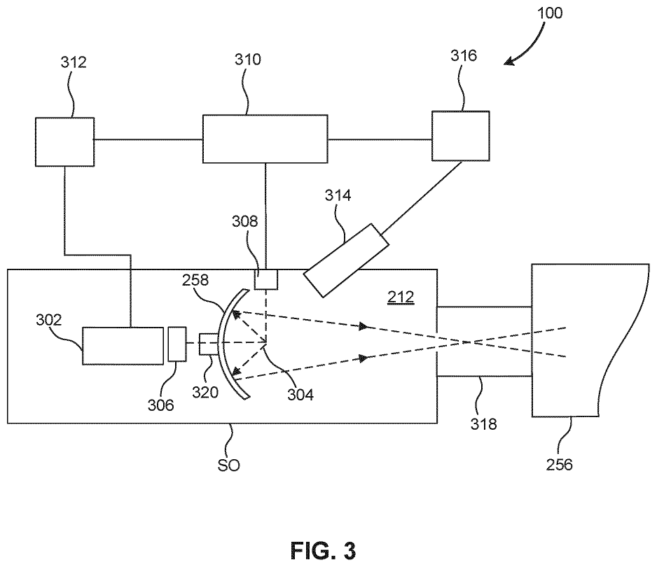

FIG. 3 shows a detailed view of a portion of lithographic apparatus 100 (e.g., FIGS. 1, 2A, and 2B), according to one or more embodiments. Elements in FIG. 3 having the same reference numbers as those in FIGS. 1, 2A, and 2B have the same or substantially similar structures and functions as described in reference to FIGS. 1, 2A, and 2B. In some embodiments, lithographic apparatus 100 may include a source collector apparatus SO having a LPP EUV light radiator. As shown, the source collector apparatus SO may include a laser system 302 for generating a train of light pulses and delivering the light pulses into a light source chamber 212. For the lithographic apparatus 100, the light pulses may travel along one or more beam paths from the laser system 302 and into the chamber 212 to illuminate a source material at an irradiation region 304 to generate a plasma (e.g., plasma region where hot plasma 210 is in FIG. 2B) that produces EUV light for substrate exposure in the exposure device 256.

In some embodiments, suitable lasers for use in the laser system 302 may include a pulsed laser device, e.g., a pulsed gas discharge CO₂ laser device producing radiation at 9.3 pm or 10.6 pm, e.g., with DC or RF excitation, operating at relatively high power, e.g., 10 kW or higher and high pulse repetition rate, e.g., 50 kHz or more. In some embodiments, the laser may be an axial-flow RF-pumped CO₂ laser having an oscillator amplifier configuration (e.g., master oscillator/power amplifier (MOPA) or power oscillator/power amplifier (POPA)) with multiple stages of amplification and having a seed pulse that is initiated by a Q-switched oscillator with relatively low energy and high repetition rate, e.g., capable of 100 kHz operation. From the oscillator, the laser pulse may then be amplified, shaped and/or focused before reaching the irradiation region 304. Continuously pumped CO₂ amplifiers may be used for the laser system 302. Alternatively, the laser may be configured as a so-called “self-targeting” laser system in which the droplet serves as one mirror of the optical cavity of the laser.

In some embodiments, depending on the application, other types of lasers may also be suitable, e.g., an excimer or molecular fluorine laser operating at high power and high pulse repetition rate. Some examples include, a solid state laser, e.g., having a fiber, rod, slab, or disk-shaped active media, other laser architectures having one or more chambers, e.g., an oscillator chamber and one or more amplifying chambers (with the amplifying chambers in parallel or in series), a master oscillator/power oscillator (MOPO) arrangement, a master oscillator/power ring amplifier (MOPRA) arrangement, or a solid state laser that seeds one or more excimer, molecular fluorine or CO₂ amplifier or oscillator chambers, may be suitable. Other suitable designs are envisaged.

In some embodiments, a source material may first be irradiated by a pre-pulse and thereafter irradiated by a main pulse. Pre-pulse and main pulse seeds may be generated by a single oscillator or two separate oscillators. One or more common amplifiers may be used to amplify both the pre-pulse seed and main pulse seed. In some embodiments, separate amplifiers may be used to amplify the pre-pulse and main pulse seeds.

In some embodiments, the lithographic apparatus 100 may include a beam conditioning unit 306 having one or more optics for beam conditioning such as expanding, steering, and/or focusing the beam between the laser system 302 and irradiation region 304. For example, a steering system, which may include one or more mirrors, prisms, lenses, etc., may be provided and arranged to steer the laser focal spot to different locations in the chamber 212. For example, the steering system may include a first flat mirror mounted on a tip-tilt actuator which may move the first mirror independently in two dimensions, and a second flat mirror mounted on a tip-tilt actuator which may move the second mirror independently in two dimensions. With the described arrangement(s), the steering system may controllably move the focal spot in directions substantially orthogonal to the direction of beam propagation (beam axis or optical axis).

The beam conditioning unit 306 may include a focusing assembly to focus the beam to the irradiation region 304 and adjust the position of the focal spot along the beam axis. For the focusing assembly, an optic, such as a focusing lens or mirror, may be used that is coupled to an actuator for movement in a direction along the beam axis to move the focal spot along the beam axis.

In some embodiments, the source collector apparatus SO may also include a source material delivery system 308, e.g., delivering source material, such as tin droplets, into the interior of chamber 212 to an irradiation region 304, where the droplets will interact with light pulses from the laser system 302, to ultimately produce plasma and generate an EUV emission to expose a substrate such as a resist coated wafer in the exposure device 256. More details regarding various droplet dispenser configurations may be found in, e.g., U.S. Pat. No. 7,872,245, issued on Jan. 18, 2011, titled “Systems and Methods for Target Material Delivery in a Laser Produced Plasma EUV Light Source”, U.S. Pat. No. 7,405,416, issued on Jul. 29, 2008, titled “Method and Apparatus For EUV Plasma Source Target Delivery”, U.S. Pat. No. 7,372,056, issued on May 13, 2008, titled “LPP EUV Plasma Source Material Target Delivery System”, and International Appl. No. WO 2019/137846, titled “Apparatus for and Method of Controlling Coalescence of Droplets In a Droplet Stream”, published on Jul. 18, 2019, the contents of each of which are incorporated by reference herein in their entirety.

In some embodiments, the source material for producing an EUV light output for substrate exposure may include, but is not necessarily limited to, a material that includes tin, lithium, xenon or combinations thereof. The EUV emitting element, e.g., tin, lithium, xenon, etc., may be in the form of liquid droplets and/or solid particles contained within liquid droplets. For example, the element tin may be used as pure tin, as a tin compound, e.g., SnBr₄, SnBr₂, SnH₄, as a tin alloy, e.g., tin-gallium alloys, tin-indium alloys, tin-indium-gallium alloys, or a combination thereof. Depending on the material used, the source material may be presented to the irradiation region at various temperatures including room temperature or near room temperature (e.g., tin alloys, SnBr₄), at an elevated temperature, (e.g., pure tin) or at temperatures below room temperature, (e.g., SnH₄), and in some cases, may be relatively volatile, e.g., SnBr₄.

In some embodiments, the lithographic apparatus 100 may also include a controller 310, which may also include a drive laser control system 312 for controlling devices in the laser system 302 to thereby generate light pulses for delivery into the chamber 212, and/or for controlling movement of optics in the beam conditioning unit 306. The lithographic apparatus 100 may also include a droplet position detection system which may include one or more droplet imagers 314 that provide an output signal indicative of the position of one or more droplets, e.g., relative to the irradiation region 304. For example, the one or more droplet imagers 314 may provide an output signal indicative of the position of a stream of droplets relative to the irradiation region 304. The droplet imager(s) 314 may provide this output to a droplet position detection feedback system 316, which can, e.g., compute a droplet position and trajectory, from which a droplet error may be computed, e.g., on a droplet-by-droplet basis, or on average. The droplet error may then be provided as an input to the controller 310, which can, for example, provide a position, direction and/or timing correction signal to the laser system 302 to control laser trigger timing and/or to control movement of optics in the beam conditioning unit 306, e.g., to change the location and/or focal power of the light pulses being delivered to the irradiation region 304 in the chamber 212. Also for the source collector apparatus SO, the source material delivery system 308 may have a control system operable in response to a signal (which in some implementations may include the droplet error described above, or some quantity derived therefrom) from the controller 310, to e.g., modify the release point, initial droplet stream direction, droplet release timing and/or droplet modulation to correct for errors in the droplets arriving at the irradiation region 304.

In some embodiments, the lithographic apparatus 100 may also include a collector optic 258, and a gas dispenser device 320. Gas dispenser device 320 may dispense gas in the path of the source material from the source material delivery system 308 (e.g., irradiation region 304). Gas dispenser device 320 may comprise a nozzle through which dispensed gas may exit. Gas dispenser device 320 may be structured (e.g., having an aperture) such that, when placed near the optical path of laser system 302, light from laser system 302 is not blocked by gas dispenser device 320 and is allowed to reach the irradiation region 304. A buffer gas such as hydrogen, helium, argon or combinations thereof, may be introduced into, replenished and/or removed from the chamber 212. The buffer gas may be present in the chamber 212 during plasma discharge and may act to slow plasma created ions, to reduce degradation of optics, and/or increase plasma efficiency. Alternatively, a magnetic field and/or electric field (not shown) may be used alone, or in combination with a buffer gas, to reduce fast ion damage. The gas may be present at partial vacuum (e.g., rarified).

In some embodiments, the lithographic apparatus 100 may also include a collector optic 258 such as a near-normal incidence collector mirror having a reflective surface in the form of a prolate spheroid (i.e., an ellipse rotated about its major axis) having, e.g., a graded multi-layer coating with alternating layers of Molybdenum and Silicon, and in some cases, one or more high temperature diffusion barrier layers, smoothing layers, capping layers and/or etch stop layers. Collector optic 258 may be formed with an aperture to allow the light pulses generated by the laser system 302 to pass through and reach the irradiation region 304. The same, or another similar aperture, may be used to allow gas from the gas dispenser device 320 to flow into chamber 212. As shown, the collector optic 258 may be, e.g., a prolate spheroid mirror that has a first focus within or near the irradiation region 304 and a second focus at a so-called intermediate region 318, where the EUV light may be output from the source collector apparatus SO and input to an exposure device 256 utilizing EUV light, e.g., an integrated circuit lithography tool. It is to be appreciated that other optics may be used in place of the prolate spheroid mirror for collecting and directing light to an intermediate location for subsequent delivery to a device utilizing EUV light. Embodiments using the collector optic CO (FIG. 2A) along with structures and functions described in reference to FIG. 3 are also envisaged.

### Example Lithographic Cell

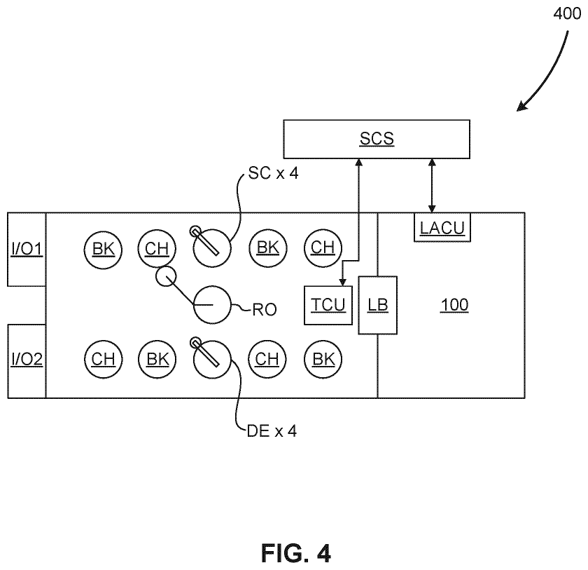

FIG. 4 shows a lithographic cell 400, also sometimes referred to a lithocell or cluster, according to some embodiments. Lithographic apparatus 100 may form part of lithographic cell 400. Lithographic cell 400 may also include one or more apparatuses to perform pre- and post-exposure processes on a substrate. Conventionally these include spin coaters SC to deposit resist layers, developers DE to develop exposed resist, chill plates CH, and bake plates BK. A substrate handler, or robot, RO picks up substrates from input/output ports I/O1, I/O2, moves them between the different process apparatuses and delivers them to the loading bay LB of the lithographic apparatus 100. These devices, which are often collectively referred to as the track, are under the control of a track control unit TCU, which is itself controlled by a supervisory control system SCS, which also controls the lithographic apparatus via lithography control unit LACU. Thus, the different apparatuses may be operated to maximize throughput and processing efficiency.

### Example Plasma Material Droplet Source

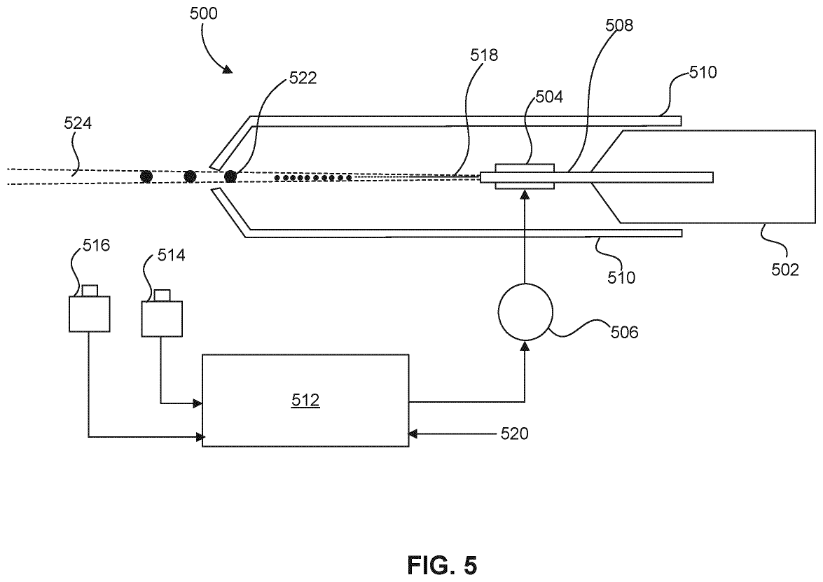

FIG. 5 shows a source material delivery system 500, according to some embodiments. In some embodiments, source material delivery system 500 may be used in a lithographic apparatus 100 (e.g., as source material delivery system 308 in FIG. 3). Source material delivery system 500 may comprise a nozzle 502, an electromechanical element 504, and a waveform generator 506. Nozzle 502 may comprise a capillary 508. Source material delivery system 500 may further comprise a shroud 510, a controller 512, a detector 514, and/or a detector 516.

As used herein, the terms “electromechanical,” “electro-actuatable,” or the like may refer to a material or structure which undergoes a dimensional change (e.g., movement, deflection, contraction, and the like) when subjected to a voltage, electric field, magnetic field, or combinations thereof and includes, but is not limited to, piezoelectric materials, electrostrictive materials, and magnetostrictive materials. Apparatuses and methods for using an electro-actuatable element to control a droplet stream are disclosed, for example, in U.S. Pub. Appl. No. 2009/0014668, titled “Laser Produced Plasma EUV Light Source Having a Droplet Stream Produced Using a Modulated Disturbance Wave” and published Jan. 15, 2009, and U.S. Pat. No. 8,513,629, titled “Droplet Generator with Actuator Induced Nozzle Cleaning” and issued Aug. 20, 2013, both of which are incorporated by reference herein in their entireties.

In some embodiments, electromechanical element 504 may be disposed on (e.g., surrounding) nozzle 502. It should be appreciated that interactions between nozzle 502 and electromechanical element 504 described herein may be directed to interactions between a pressure-sensitive element of nozzle 502 and electromechanical element 504 (e.g., electromechanical element 504 is disposed on capillary 508). Waveform generator 506 may be electrically coupled to electromechanical element 504. Controller 512 may be electrically coupled to waveform generator 506.

In some embodiments, an EUV-generating-plasma may be generated by irradiating target material (e.g., Sn) with a laser, which ionizes the target material. The target material may be provided as a stream of coalesced droplets that intersects the laser path. Source material delivery systems 500 and 300 (FIG. 3) may be referred to as droplet generator apparatuses, droplet generation devices, and the like.

In some embodiments, nozzle 502 may eject initial droplets of target material, shown in FIG. 5 as a stream of target material 518. Electromechanical element 504 and waveform generator 506 allow for the manipulation of stream dynamics to convert the stream of target material 518 to coalesced droplets 522. Coalesced droplets 522 can be detected by detector 514 and/or detector 516 to generate a signal (e.g., a detection signal). As used herein, the term “detect” or the like may be used to refer to capturing an image (e.g., using a camera) of the droplet and/or binary indication of the presence or absence of a droplet or when a droplet crosses a given location (e.g., using a laser curtain). Detectors 514 and 516 may be trigger detectors, gating detectors, gate detectors or other suitable detectors that generate a detection signal in response to a fulfillment of one or more conditions, for example the detected presence of a droplet. Detectors 514 and 516 may detect the direction and location of the stream of coalesced droplets 522 with respect to a desired target region such as irradiation region 304 of FIG. 3. One of detectors 514 and 516 may be an image capture device and the other may be a gate detector. Controller 512 may determine properties of stream of target material 518 based on the signal from detector 514. Properties of the stream of target material 518 may comprise, for example, velocity profile of the droplet stream at the detection point, gap (time and/or distance) between droplets, presence of uncoalesced droplets (satellite droplets, or simply “satellites”), droplet size, coalescence length, droplet path (or aim), and the like. Controller 512 may use the information from detectors 514 and/or 516 to generate a feedback signal to control operations and/or adjustments of, e.g., gating waveform generator 506 or to adjust an aim of nozzle 502 to more accurately aim the droplet path).

It is desirable to achieve interaction between the coalesced droplets 522 and a laser because it is this interaction between the coalesced droplets 522 and the laser that ionizes the coalesced droplets 522, and creates a plasma that produces EUV radiation. In some embodiments, variations in the interaction between a droplet and the laser may affect efficiency and stability of EUV radiation. Destabilization may adversely impact lithographic processes that uses the EUV radiation. Therefore, it is desirable to create and control the interaction between the droplets and the laser such that EUV generation is stable (e.g., reduction of fluctuations of intensity). In some embodiments, stable EUV production may rely on achieving a coalesced droplets 522 that have uniform and consistent characteristics over long periods of operation. In-flight coalescence mechanics dictate that source material delivery system 500 be placed at some distance away from irradiation region 304 (FIG. 3). Consistent coalescence of droplets may be achieved by positioning source material delivery system 308 (or its nozzle) some distance away from irradiation region 304 (FIG. 3), for example at a distance of 700 mm or more from primary focus. The term “primary focus” may be used herein to refer to an optimum region (e.g., within irradiation region 304 (FIG. 3)) at which the radiation from laser system 302 (FIG. 3) may optimally intersect coalesced droplets 522 to produce highly stable and efficient EUV radiation.

Structures and functions in embodiments of the present disclosure may reduce uncertainty for the aiming of the droplet stream. To provide additional context for embodiments of droplet stream alignments, it is instructive to describe tolerances of nozzle construction.

In some embodiments, when installing source material delivery system 500 in a lithographic apparatus, a rigorous alignment procedure may be performed to point the droplet stream in the correct direction—toward the primary focus. As an example, the expected direction of the droplet stream may be estimated by performing measurements on the structure of capillary 508. While a steering system may be provided for the nozzle, the range of adjustments of the nozzle steering system may be severely constrained by the overall design of the EUV illumination system. Therefore, it is desirable to aim the nozzle as optimally as possible during installation so as to minimize the need for additional steering adjustments.

In some embodiments, the structural measurements of capillary 508 may be performed using a coordinate measuring machine (CMM). The CMM may comprise a microscope and probes for touching numerous points on capillary 508 to take coordinate measurements. Based on the measurements, the CMM may determine a given position and a given pointing direction for capillary 508. In other words, the CMM may estimate the pointing direction of capillary 508.

In some embodiments, there may be geometric features inherent to the nozzle that cause an unknown spread of droplet locations (e.g., directional uncertainty). This is represented in FIG. 5 as directional uncertainty 524. Even with accurate CMM measurements, there are uncertainties in the internal features of capillary 508, which are based on inherent tolerances of the manufacturing process. For example, a best case scenario for directional uncertainty 524 may be a variation of about +/−1.3 degrees. It is noted that capillary 508 may be constructed out of glass, which is provided as a non-limiting example as other suitable capillary materials may also be used.

In some embodiments, though the stability of the droplet path may be stable over time (e.g., minimal fluctuations during operation), directional uncertainty 524 may be associated with a fresh installation of source material delivery system 500 in an EUV illumination system. A reason for this is that CMM measurements are performed ex-situ due to practical limitations of implementing a CMM within an illumination system. When source material delivery system 500 is first installed in an EUV illumination system, it may be that the path of the droplet stream is misdirected by an amount that exceeds the correction ability of the previously mentioned steering system. This scenario can result in a costly and complex rebuild of the illumination system or replacement of source material delivery system 500 which may not guarantee that the aim issues are solved.

In some embodiments, the material and design structure of capillary 508 may have associated uncertainties. If the nozzle construction is altered on a redesign, it may be that the new design may have even larger uncertainties (e.g., +/−2.0 degrees for directional uncertainty 524). Furthermore, too large of an uncertainty may result in the droplets coming into contact with ancillary devices near the path of the droplet stream, resulting in contamination of the struck devices.

Structures and functions in embodiments of the present disclosure may address at least the issues noted above regarding directional uncertainty 524.

### Example Droplet Generator Alignment Mechanism

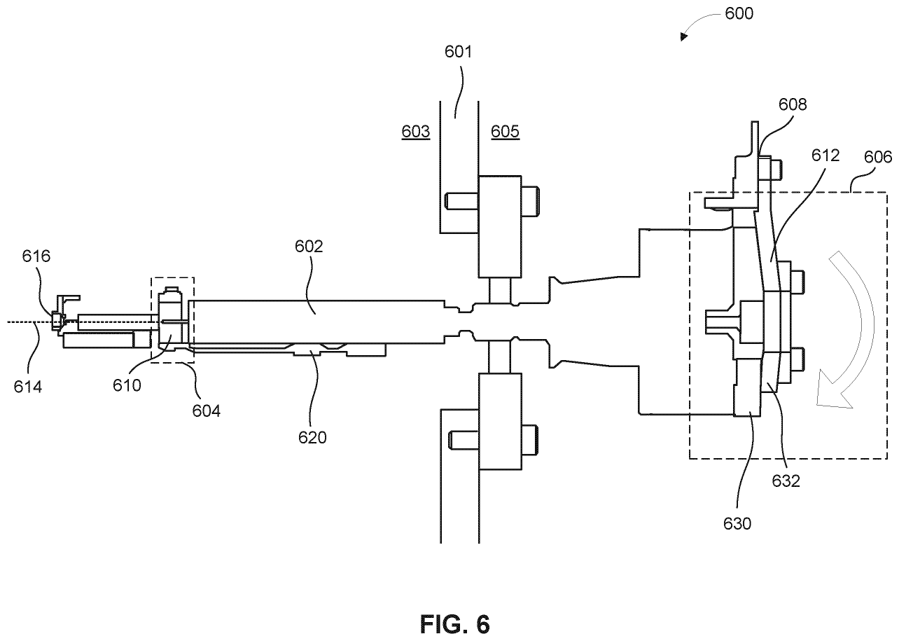

FIG. 6 shows a cross-sectional view of a droplet generator apparatus 600, according to some embodiments. In some embodiments, droplet generator apparatus 600 may be used as source material delivery systems 308 (FIG. 3) and 500 (FIG. 5). Droplet generator apparatus 600 may comprise a nozzle 602, an aperture structure 616, and an alignment mechanism. The alignment mechanism may be provided as separate portions, for example, as portions 604 and 606 (e.g., a “first portion of the alignment mechanism” and a “second portion of the alignment mechanism”). In some embodiments, enumerative adjectives (e.g., “first,” “second,” “third,” or the like) may be used as a naming convention and are not intended to indicate an order or hierarchy (unless otherwise noted). For example, the terms “first portion” and “second portion” may distinguish two portions, but need not specify if the sections have a particular order or hierarchy. Furthermore, an element in a drawing is not limited to any particular enumerative adjective. For example, portion 604 may just as well be referred to as a second section, while the other portion(s) may be given other distinguishing enumerative adjective(s).

In some embodiments, droplet generator apparatus 600 may be affixed to an illumination system that comprises walls 601 of a chamber (e.g., via a vacuum flange or other interface). The gas in the chamber may be evacuated out (e.g. partially) to achieve a rarified environment as described earlier in reference to FIG. 3. The environment inside of the chamber where the droplets are generated (e.g., to the left in FIG. 6) may be referred to as vacuum-side 603. The environment outside of the chamber (e.g., to the right) may be referred to as atmosphere-side 605. Accordingly, droplet generator apparatus 600 may comprise an outside surface 608.

In some embodiments, portion 604 of the alignment mechanism may comprise a corresponding adjustment mechanism 610 (e.g., a “first adjustment mechanism”). Portion 606 of the alignment mechanism may comprise a corresponding adjustment mechanism 612 (e.g., a “second adjustment mechanism”). Portion 606 of the alignment mechanism is disposed on atmosphere-side 605 and may be coupled to an outside surface 608 of the droplet generator apparatus. Droplet generator apparatus may further comprise a cradle 620.

In some embodiments, adjustment mechanism 610 may comprise a spherical bearing to provide a pivot for cradle 620 and nozzle 602. A spherical plain bearing may allow angular rotation in multiple directions and about a central pivot point. Cradle 620 may support nozzle 602. Cradle 620 may be rigidly affixed to both adjustment mechanism 610 and nozzle 602 such that adjustments to nozzle 602 (e.g., directional change) may be performed with adjustment mechanism 610 as the pivot. The tip of nozzle 602 (or the tip of capillary 508 (FIG. 5)) may be disposed at the center of rotation of adjustment mechanism 610. The droplets from nozzle 602 may travel in a droplet stream substantially along a droplet path 614. An operator may adjust the direction or position, of nozzle 602 by using adjustment mechanism 612 at atmosphere-side 605. By adjusting the position of nozzle 602, the adjustment mechanism may be used to align the droplet path 614 with respect to a target region such irradiation region 304. The vacuum-to-atmosphere interface of droplet generator apparatus 600 comprises a movement budget that allows adjustment mechanism 612 a range of motion while maintaining a vacuum seal.

Adjustment mechanism 612 may comprise a base 630 that is rigidly coupled to nozzle 602. An operator may adjust base 630 to make adjustments to the direction of nozzle 602 and droplet path 614. In this manner, adjustment mechanism 612 may adjust adjustment mechanism 610, for example by rotation of the spherical bearing of adjustment mechanism 610, in order to align nozzle 602 and droplet path 614, i.e. the direction of the droplet stream. Aperture structure 616 may comprise a shielding structure having an aperture. The shielding structure may provide shielding when droplets travel substantially off-path of droplet path 614, for example, when the operation of droplet generator apparatus 600 is ramping up or down. Aperture structure 616 may be disposed at a distal end of the nozzle alignment mechanism. The droplets may comprise heated tin, which may be highly corrosive. Tin contamination may adversely affect a performance of the EUV source that has an implementation of droplet generator apparatus 600. Furthermore, tin contamination may affect internal components of droplet generator apparatus 600. Therefore, the alignment mechanism is fabricated with corrosion-resistant material (e.g., stainless steel having a titanium nitride coating).

In some embodiments, adjustment mechanism 612 may also comprise a mounting plate 632 to support additional elements for adjustments.

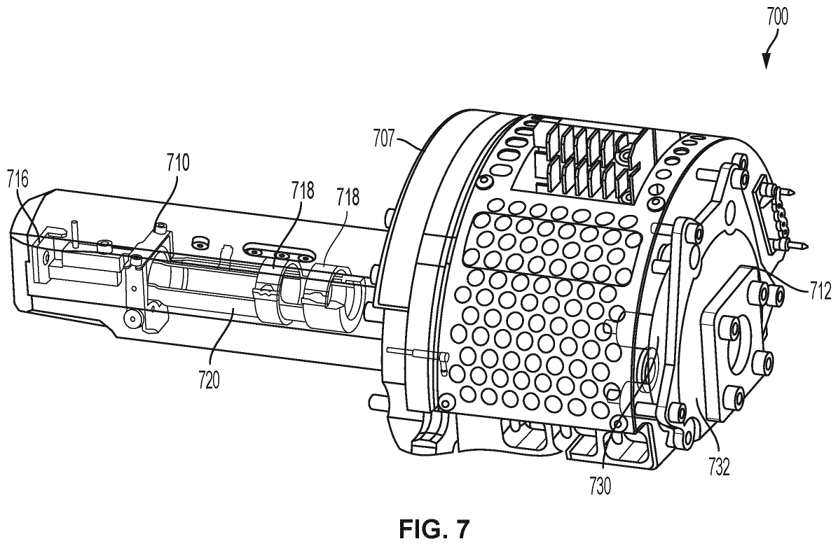

FIG. 7 shows a perspective view of a droplet generator apparatus 700, according to some embodiments. In some embodiments, droplet generator apparatus 700 may be a different view of droplet generator apparatus 600 (FIG. 6). Unless otherwise noted, structures and functions described previously for elements of FIG. 6 may also apply to similarly numbered elements of FIG. 7 (e.g., reference numbers sharing the two right-most numeric digits). At least some structures and functions of elements of FIG. 7 should be apparent from descriptions of corresponding elements of FIG. 6.

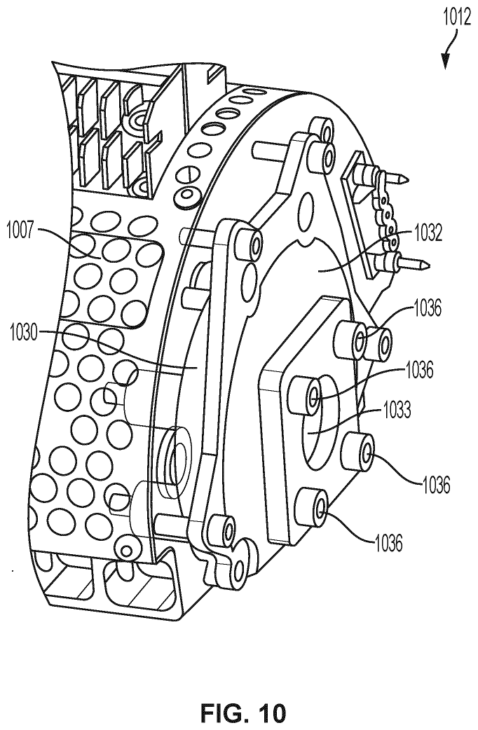

In some embodiments, FIG. 7 shows a frame 707, a cradle 720, adjustment mechanisms 710 and 712, an aperture structure 716 disposed at an end section of cradle 720, clamps 718, a base 730, and a mounting plate 732 of droplet generator apparatus 700. Clamps 718 may be used to rigidly affix nozzle 602 (FIG. 6) to cradle 720. Cradle 720 and aperture structure 716 may be free to move relative to frame 707 when making alignment adjustments. An exterior side of adjustment mechanism 712 is shown in FIG. 7. The specific parts of adjustment mechanism 712 shown here may be used to lock an alignment once adjustments of nozzle 602 (FIG. 6) are completed (further described below in reference to FIGS. 10-12).

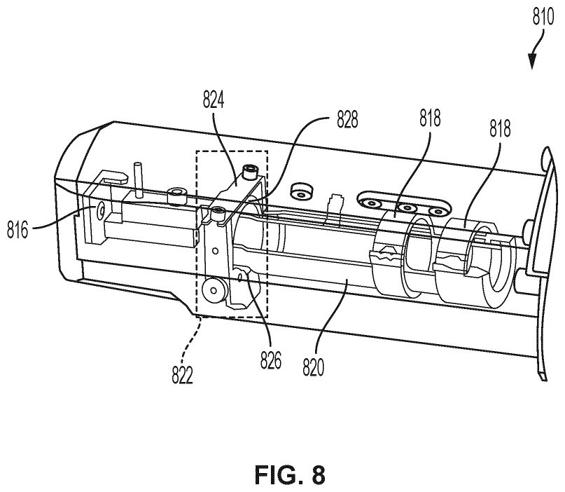

FIG. 8 shows a magnified view of an adjustment mechanism 810, according to some embodiments. In some embodiments, adjustment mechanism 810 may be a different view of adjustment mechanisms 610 and/or 710 (FIGS. 6 and 7). Unless otherwise noted, structures and functions described previously for elements of FIGS. 6 and 7 may also apply to similarly numbered elements of FIG. 8 (e.g., reference numbers sharing the two right-most numeric digits). At least some structures and functions of elements of FIG. 8 should be apparent from descriptions of corresponding elements of FIGS. 6 and 7. In some embodiments, FIG. 8 shows aperture structure 816, clamp(s) 818, cradle 820, and

spherical bearing 822 of adjustment mechanism 810. Spherical bearing 822 may comprise a spring 824, a recessed structure 826, and a spherical structure 828. Spherical structure 828 may comprise a hollow sphere. Two opposing end caps of the hollow sphere are removed so as to provide access through spherical structure 828. In other words, spherical structure 828 may have an annular or ring-like structure with a spherical exterior (e.g., as opposed to a straight cylinder). The assembly that supports aperture structure 816 may be rigidly affixed to spherical structure 828 or cradle 820 so that, when nozzle 602 (FIG. 6) is adjusted, aperture structure 816 moves with droplet path 614 (FIG. 6). Spring 824 may be used to secure spherical structure 828 to recessed structure 826 while also allowing spherical structure 828 to rotate in place. Spherical structure 828 may rotate based on adjustment mechanism 612 (FIG. 6) adjusting first adjustment mechanism 610 (FIG. 6).

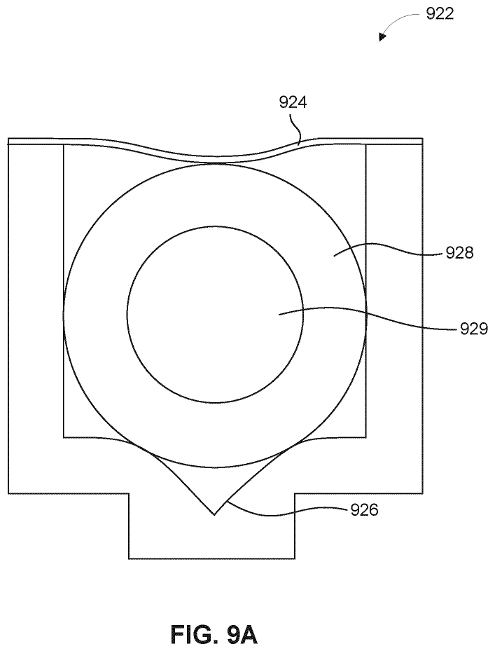

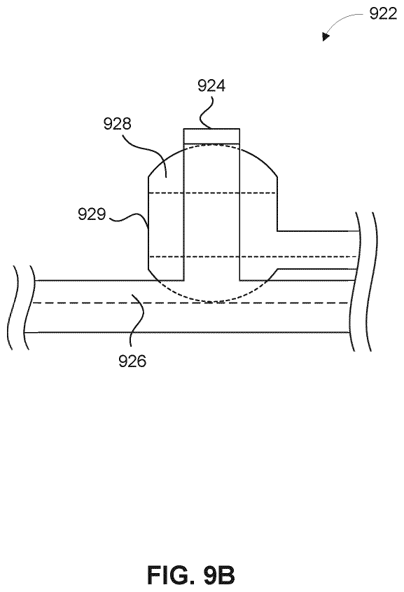

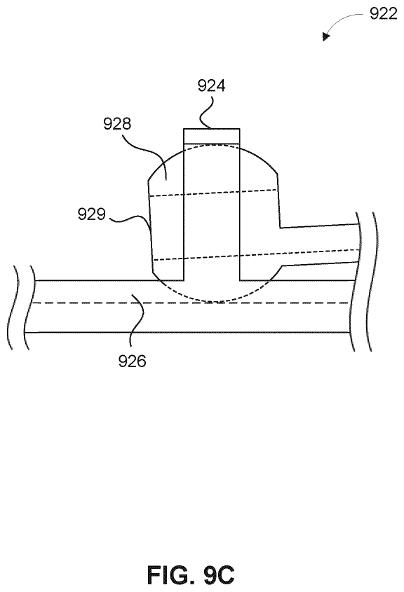

FIG. 9A shows a cross-sectional view of a spherical bearing 922, according to some embodiments. In some embodiments, spherical bearing 922 may be a different view of spherical bearing 822 (FIG. 8) (e.g., view is with droplet generator pointed out of the page). Unless otherwise noted, structures and functions described previously for elements of FIG. 8 may also apply to similarly numbered elements of FIG. 9 (e.g., reference numbers sharing the two right-most numeric digits). At least some structures and functions of elements of FIG. 9 should be apparent from descriptions of corresponding elements of FIG. 8.

In some embodiments, spherical structure 928 may be supported by recessed structure 926. Recessed structure 926 may be a groove (e.g., a V-groove). Spring 924 may be a leaf spring. Spring 924 may bias spherical structure 928 toward recessed structure 926 with enough force to prevent spherical structure 928 from decoupling, but also a small enough force to allow spherical structure 928 to rotate. Recessed structure 926 may be affixed to a frame of droplet generator apparatus (e.g., 600 or 700 (FIGS. 6 and 7)) while spherical structure 928 is capable of relative rotation. The allowable rotational range may be, for example, about +/−2.0 degrees. Spherical structure 928 may be hollow and open at two opposing ends such that an opening 929 is available to provide line-of-sight access for droplet path 614 (FIG. 6).

FIGS. 9B and 9C shows a different cross-sectional view of spherical bearing 922, according to some embodiments. In this view, the spherical shape of spherical structure 928 is clearer. Spherical structure 828 (FIG. 8) may be the same as spherical structure 928. FIG. 9B shows spherical structure 928 in a nominal position (e.g. unrotated). FIG. 9C shows an adjusted position of spherical structure 928 (e.g., rotated). Though the illustrated adjustment is up and down the page, it should be appreciated that adjustments may also include rotations in and out of the page and/or left and right translations along recessed structure 926.

FIG. 10 shows a magnified view of an adjustment mechanism 1012, according to some embodiments. In some embodiments, adjustment mechanism 1012 may be a different view of adjustment mechanisms 612 and/or 712 (FIGS. 6 and 7). Unless otherwise noted, structures and functions described previously for elements of FIGS. 6 and 7 may also apply to similarly numbered elements of FIG. 10 (e.g., reference numbers sharing the two right-most numeric digits). At least some structures and functions of elements of FIG. 10 should be apparent from descriptions of corresponding elements of FIGS. 6 and 7.

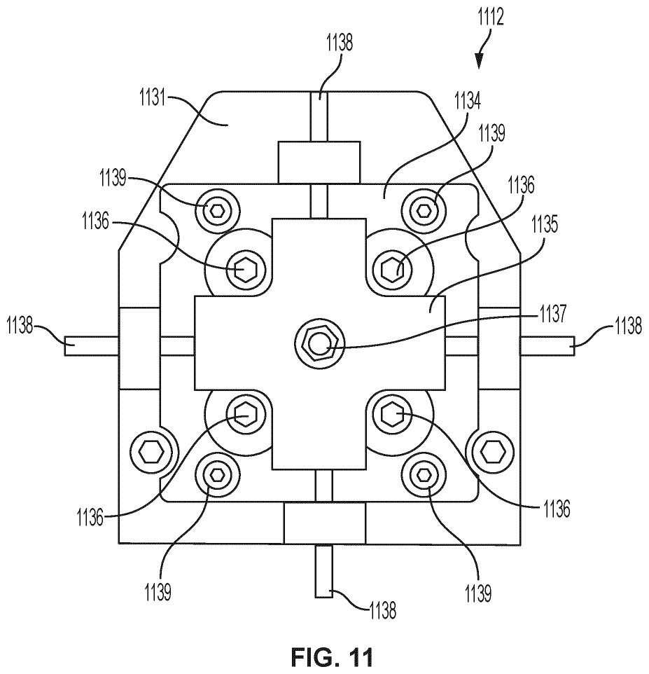

In some embodiments, adjustment mechanism 1012 may comprise a layering of adjustment and locking elements. Particularly, the mechanisms emphasized in FIG. 10 may belong to a locking category (e.g., preventing relative movements once locked). The locking elements may be disposed closer to an interior of droplet generator apparatus 600 (FIG. 6) than the actuating elements (e.g., disposed closer to the nozzle; toward the left of the drawing). The actuating elements will be described further below in reference to FIG. 11.

In some embodiments, adjustment mechanism 1012 may comprise a base 1030, a mounting plate 1032, and locking devices 1036. Base 1030 may be rigidly affixed to nozzle 602 (FIG. 6). Mounting plate 1032 may be affixed to a frame 1007 (e.g., a frame of droplet generator 600 (FIG. 6)).

In some embodiments, base 1030 may move with respect to mounting plate 1032 which remains stationary, when adjustment mechanism 1012 is in an unlocked state. In the unlocked state, a separation between base 1030 and mounting plate 1032 may be, for example, approximately 0.5 mm or more, 1.0 mm or more, 2.0 mm or more, or the like. Due to the small separation, it is desirable for an interface of base 1030 and mounting plate 1032 to have conforming shapes (e.g., conterminous shapes) that allow base 1030 to move relative to mounting plate 1032 despite being in close proximity to one another. Therefore, in some embodiments, the interface of base 1030 and mounting plate 1032 may be a semi-spherical interface that has a center of radius disposed at the pivot defined by adjustment mechanism 610 (FIG. 6).

In some embodiments, mounting plate 1032 may comprise an opening 1033. Opening 1033 may allow an adjustment member to access base 1030 for adjustments.

In some embodiments, locking devices 1036 may be engaged (e.g., bolts may be tightened) to engage a locked state of adjustment mechanism 1012. In the locked state, mounting plate 1032 may be disposed on base 1030 (e.g., in contact) such that friction may prevent relative movement between one another. In the unlocked state, while mounting plate 1032 remains stationary, base 1030 is moveable with respect to mounting plate 1032. Base 1030 is directly coupled to the droplet generator such that the adjustment of base 1030 (as part of adjustment mechanism 612) causes a proportional actuation of nozzle 620 and subsequent proportional rotation of adjustment mechanism 610.

FIG. 11 shows adjustment mechanism 1112, according to some embodiments. In some embodiments, adjustment mechanism 1112 may be a different view of adjustment mechanisms 612, 712, and/or 1012 (FIGS. 6, 7 and 10) and illustrating additional components. Unless otherwise noted, structures and functions described previously for elements of FIGS. 6, 7 and 10 may also apply to similarly numbered elements of FIG. 11 (e.g., reference numbers sharing the two right-most numeric digits). At least some structures and functions of elements of FIG. 11 should be apparent from descriptions of corresponding elements of FIGS. 6, 7, and 10.

In some embodiments, adjustment mechanism 1112 may comprise a layering of adjustment and locking elements. Particularly, the mechanisms emphasized in FIG. 11 may belong to an adjustment category (e.g., for adjusting direction of droplet path 614 (FIG. 6)), though some locking elements may be shown for context (e.g., locking devices 1136). The adjustment elements may be disposed further from an interior of droplet generator apparatus 600 (FIG. 6) than the locking elements.

In some embodiments, adjustment mechanism 1112 may comprise a mounting structure 1131, a pad 1134, an intermediate structure 1135, fasteners 1137 and 1139, and adjustment members 1138. Intermediate structure 1135 may be a standoff (e.g., a threaded separator). Fasteners 1137 and 1139 may be threaded fasteners (e.g., bolts). Fastener 1137 may affix intermediate structure 1135 to base 1030 (FIG. 10) through opening 1033 (FIG. 10) (and through openings of mounting structure 1131 and pad 1134, though this is not shown). Adjustment members 1138 may be set-screws that are in contact with intermediate structure 1135. Adjustment members 1138 may be rotated to move intermediate structure 1135 up, down, left, or right (relative to the page) By moving intermediate structure 1135, base 1030 (FIG. 10) may be moved, which in turn may adjust the directions of nozzle 602 and droplet path 614 (FIG. 6). For example, using adjustment members 1138, adjustment mechanism 1112 (along with adjustment mechanism 610 FIG. 6)) may adjust a position of nozzle 602 (FIG. 6) within a range of approximately 0.01 degrees to 1.75 degrees. The adjustment may be in two dimensions—that is, along two axes or with respect to stationary horizontal and vertical planes of the nozzle alignment mechanism. In other words, the adjusting of intermediate structure 1135 of portion 606 (FIG. 6) results in a proportional adjustment of portion 604 (FIG. 6).

In some embodiments, mounting structure 1131 may be rigidly coupled to mounting plate 1032 (FIG. 2) (i.e., stationary relative to frame 1007 (FIG. 10)). Pad 1134 may be affixed to mounting structure 1131 using fasteners 1139. In other words, pad 1134 may be rigidly coupled to mounting plate 1032 and frame 1007 (FIG. 10).

In some embodiments, adjustments may be performed when adjustment mechanism 1112 is in an unlocked state. To lock adjustment mechanism 1112 after adjustments, locking devices 1136 may be engaged (e.g., bolts may be tightened). Mounting structure 1131 and pad 1134 may have openings for each of locking devices 1136 to allow access to locking devices 1136.

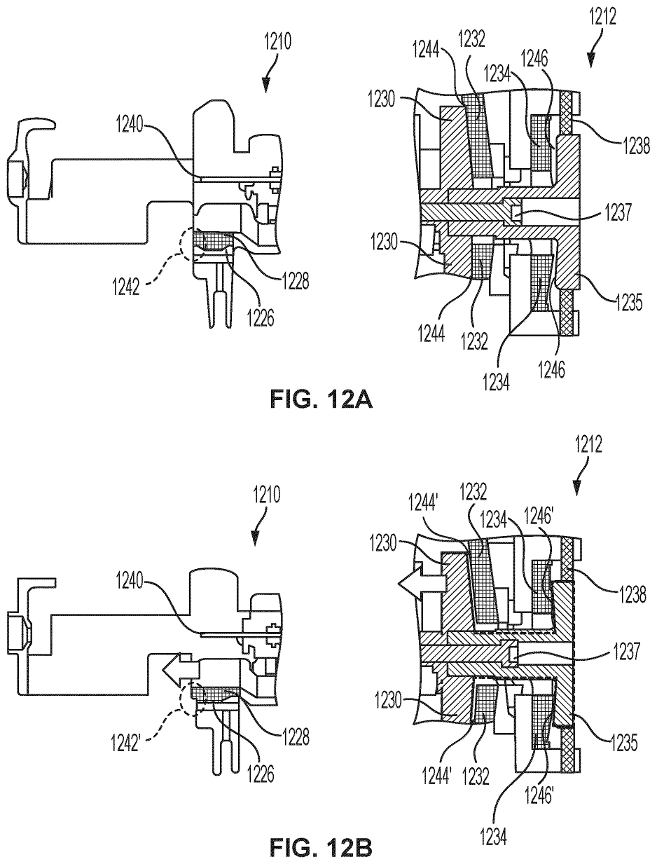

In some embodiments, pad 1134 and intermediate structure 1135 may be in contact or may be separated depending on the locked/unlocked state of adjustment mechanism 1112 (additional details described below in reference to FIG. 12). For moving intermediate structure 1135 relative to pad 1134 while in contact, the interface of pad 1134 and intermediate structure 1135 may be may be a spherical interface that has a center of radius disposed at the pivot defined by adjustment mechanism 610 (FIG. 6).

FIGS. 12A and 12B show adjustment mechanisms 1210 and 1212, according to some embodiments. The right-hand side portions of FIGS. 12A and 12B show a cross-section of the mechanism of FIG. 11, while the mechanism of FIG. 11 can be understood to be disposed over the mounting plate (632, 732, or 1032 in FIG. 6, 7, or 10). In some embodiments, elements of FIGS. 12A and 12B may correspond with elements of FIGS. 6-11. In particular, adjustment mechanism 1210 corresponds to the left most portion of adjustment mechanism 610 shown in FIG. 6. Unless otherwise noted, structures and functions described previously for elements of FIGS. 6-11 may also apply to similarly numbered elements of FIGS. 12A and 12B (e.g., reference numbers sharing the two right-most numeric digits). At least some structures and functions of elements of FIGS. 12A and 12B should be apparent from descriptions of corresponding elements of FIGS. 6-11.

In some embodiments, FIG. 12A may correspond to a locked state. Adjustment mechanism 1210 comprises a recessed structure 1226 and a spherical structure 1228 supported in the recessed structure. A capillary tip 1240 (e.g., of a nozzle 602 (FIG. 6)) may be disposed approximately at the center of rotation of spherical structure 1228. An emphasized structure 1242 is emphasized in a dotted circle. The emphasis illustrates a difference between locked and unlocked states of the alignment mechanism. The full context of emphasized structure 1242 is conveyed when compared to emphasized structure 1242′ in FIG. 12B.

In some embodiments, adjustment mechanism 1212 comprises a base 1230, a mounting plate 1232, a pad 1234, an intermediate structure 1235, a fastener 1237, and adjustment members 1238. An interface 1244 denotes the interface of base 1230 and mounting plate 1232. The confronting surfaces of base 1230 and mounting plate 1232 are conterminous, as illustrated in FIG. 12A. In other words, the shapes of the surfaces are coincident so as to match when mated. An interface 1246 denotes the interface of pad 1234 and intermediate structure 1235. In the locked state, interface 1244 exhibits no gap while interface 1246 exhibits a gap. At interface 1244, base 1230 and mounting plate 1232 are in contact with one another, providing friction therebetween to engage the locking. The contact and friction may be provided by tightening locking devices 1036/1136 (FIGS. 10 and 11).

In some embodiments, FIG. 12B may correspond to an unlocked state for allowing adjustments. Here, changes in the mechanisms are represented by emphasized structure 1242′, interface 1244′, and interface 1246′. It is shown at emphasized structure 1242 that spherical structure 1228 has creeped slightly forward (direction indicated by a white arrow). The forward creep is an artifact due to the unlocked state at adjustment mechanism 1212 having shifted certain elements forward. The forward creep may be approximately 2.0 mm or less, 1.5 mm or less, or 1.0 mm or less.

In some embodiments, to unlock adjustment mechanism 1212, locking devices 1036/1136 (FIGS. 10 and 11) may be released. The release may causing base 1030 to separate from mounting plate 1032 (FIG. 10), which in turn causes intermediate structure 1135 to be pulled forward (direction indicated by a white arrow, and the structures that have crept forward are indicated via a white-dotted outline). Interface 1244′ shows that a gap has formed between base 1230 and mounting plate 1232, thereby undoing the friction that provided for the locking. Conversely, interface 1246′ shows that pad 1234 and intermediate structure 1235 are now in contact. Interface 1246′ may be used as a physical stop to prevent spherical structure 1228 from completely sliding off of recessed structure 1226 as a result of the forward creep.

While in contact and in the unlocked state, intermediate structure 1235 may still be moved relative to pad 1234 by adjusting adjustment members 1238. When intermediate structure 1235 is moved by adjusting the adjustment members 1238, this causes the spherical structure 1228 and the nozzle to rotate. To facilitate this, interface 1246′ may be a spherical interface wherein the center of radius of the sphere, is disposed at capillary tip 1240. To reduce friction on contact, one of the contact surface may comprise a material with low coefficient of friction (e.g., a polymer, a plastic, Teflon coat, or the like). For example, pad 1234 may be manufactured from a block of plastic. After adjustments, locking devices 1036/1136 (FIGS. 10 and 11) may be engaged and the setup may return to the state shown in FIG. 12A.

It was mentioned that, in some embodiments, structures like capillary tip 1240 and capillary 508 (FIG. 5) may exhibit manufacturing uncertainties until they are used for the first time to generate a droplet stream along droplet path 614 (FIG. 6). Once the direction of droplet path 614 is observed (e.g., using a detector), the droplet generator apparatus may no longer be beholden to the large uncertainty represented by uncertainty 524 (FIG. 5), whereby momentary fluctuations of droplet direction may be much smaller (e.g., achieve a steady state). Should the droplet stream be non-conforming (i.e., not on-target at primary focus), the alignment mechanisms disclosed herein may be used to align droplet path 614 (FIG. 6) in situ with the aid of metrology (e.g., a camera).

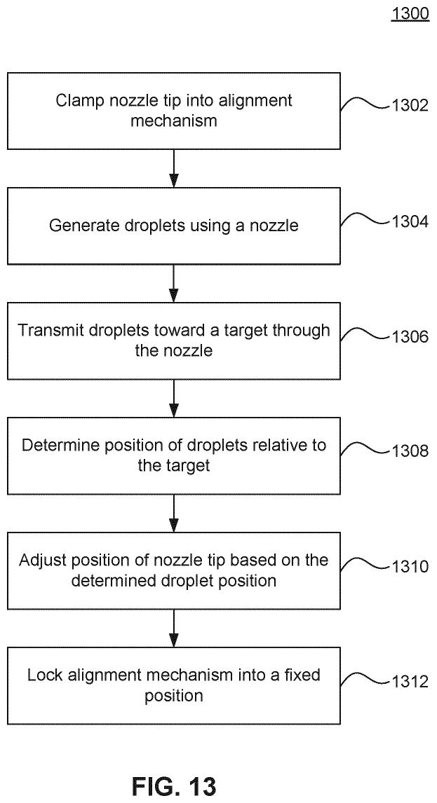

FIG. 13 shows operations for a method 1300 for adjusting a direction of a droplet stream, according to some embodiments. At operation 1302, a nozzle may be clamped into an alignment mechanism. At operation 1304, droplets may be generated from the nozzle. At operation 1306, the droplets may be transmitted toward a target region (e.g., primary focus) through the nozzle. At operation 1308, a position of the droplets relative to the target region may be determined. To determine the position, detectors 514 and/or 516 (FIG. 5) may be used. Detectors 514 and/or 516 (FIG. 5) may comprise a CCD camera, a strobe light shadowgram device, or the like. At operation 1310, a position or direction of the nozzle may be adjusted based on the determined droplet position. The adjusting may be performed using the structures and functions of alignment and adjustment mechanisms described herein. At operation 1312, once it is determined that the adjustments have successfully caused the droplets to be directed toward the target region, the alignment mechanism may be locked into a fixed position.

The method of FIG. 13 may be performed in any conceivable order and it is not required that all steps be performed. Moreover, the method of FIG. 13 described above merely reflect an example of operations and are not limiting. That is, further method operations are envisaged based on embodiments described in reference to FIGS. 1-12.

The method of FIG. 13 and the preceding drawings and embodiments are directed to an alignment system that may be advantageously locked into an alignment position as in operation 1312 of FIG. 13. According to these embodiments, the alignment mechanism is installed on the droplet generator assembly and the droplet generator assembly including the components described above are locked into position and any fine tuning or steering may be carried out using other means.

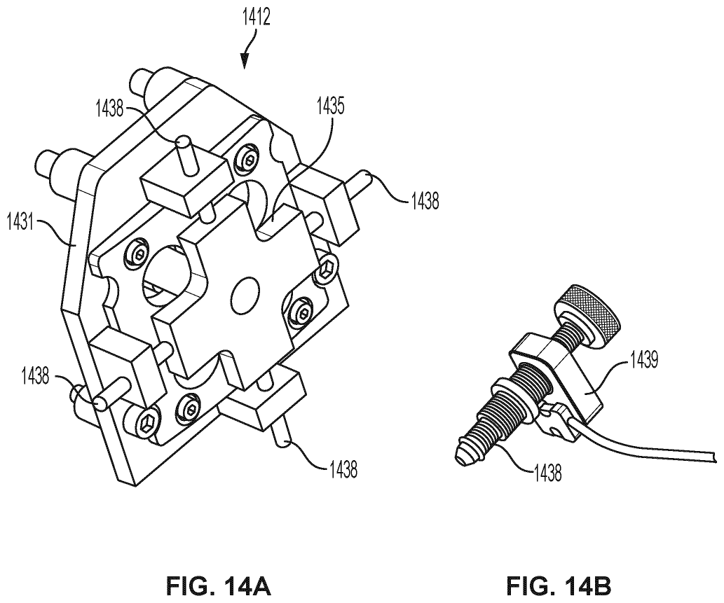

According to other embodiments such as shown in FIGS. 14A and 14B, the components are not locked into position and the positioning mechanism described and illustrated above, serves as a steering mechanism to fine tune the position of the droplet stream emanating from the nozzle such as nozzle 602.

FIG. 14A shows steering mechanism 1412, according to some embodiments. In some embodiments, steering mechanism 1412 may be a different view of adjustment mechanisms 612, 712, 1012 and/or 1212 (FIGS. 6, 7, 10, and 11) and illustrating additional components. Unless otherwise noted, structures and functions described previously for elements of FIGS. 6, 7, 10 and 11 may also apply to similarly numbered elements of FIG. 14A (e.g., reference numbers sharing the two right-most numeric digits). At least some structures and functions of elements of FIG. 14A should be apparent from descriptions of corresponding elements of FIGS. 6, 7, 10, and 11.

In some embodiments, steering mechanism 1412 may comprise a mounting structure 1431, an intermediate structure 1435, and steering members 1438. Steering members 1438 may be motorized or manually adjusted.

FIG. 14B shows an example of a motorized steering member 1438, according to some embodiments. In some embodiments, steering member 1438 may be a piezo-actuated steering member 1438 comprising a piezo actuator. For a plurality of steering members, a corresponding plurality of piezo actuators can actuate the plurality of steering members to steer the droplet stream. The actuation can allow for fine control of the droplet path (see e.g., droplet path 614 (FIG. 6)).

In some embodiments, the mechanisms directed to droplet-path steering described herein can be characterized as being part of a gimbal mechanism (e.g., a nozzle-steering gimbal). The mechanisms directed to droplet-path steering described herein can allow for removal or simplification of cooling water circuits, removal or simplification of gravity compensation (a limitation for Lorentz actuators), reduced footprint and volume requirements, and/or reduced cost of materials and construction.

Although specific reference can be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, LCDs, thin-film magnetic heads, etc. The skilled artisan will appreciate that, in the context of such alternative applications, any use of the terms “wafer” or “die” herein can be considered as synonymous with the more general terms “substrate” or “target portion”, respectively. The substrate referred to herein can be processed, before or after exposure, in for example a track unit (a tool that typically applies a layer of resist to a substrate and develops the exposed resist), a metrology unit and/or an inspection unit. Where applicable, the disclosure herein can be applied to such and other substrate processing tools. Further, the substrate can be processed more than once, for example in order to create a multi-layer IC, so that the term substrate used herein may also refer to a substrate that already contains multiple processed layers.

Although specific reference may have been made above to the use of embodiments of the present disclosure in the context of optical lithography, it will be appreciated that the present disclosure can be used in other applications, for example, droplet generators used in the energy industry, fuel injection, ink jets, or the like.

It is to be understood that the phraseology or terminology herein is for the purpose of description and not of limitation, such that the terminology or phraseology of the present disclosure is to be interpreted by those skilled in relevant art(s) in light of the teachings herein.

The term “substrate” as used herein describes a material onto which material layers are added. In some embodiments, the substrate itself can be patterned and materials added on top of it may also be patterned, or may remain without patterning.

While specific embodiments of the present disclosure have been described above, it will be appreciated that the present disclosure can be practiced otherwise than as described. The description is not intended to limit the present disclosure.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the present disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein.

The breadth and scope of protected subject matter should not be limited by any of the above-described exemplary embodiments, but should be defined only in accordance with the following claims and their equivalents.

Other aspects of the invention are set out in the following numbered clauses:

1. A system comprising:
a first portion of an alignment mechanism coupled to a nozzle and disposed within a droplet generation device; and
a second portion of the alignment mechanism coupled to an outside surface of the droplet generation device,
wherein the second portion comprises a second adjustment mechanism configured to adjust a first adjustment mechanism of the first portion in order to adjust a position of the nozzle and align a path of a droplet stream with respect to a target region.

2. The system of clause 1, wherein the first adjustment mechanism comprises:
a cradle configured to hold the nozzle;
at least one clamp configured to affix the nozzle to the cradle; and
a spherical bearing, comprising:
a spherical structure rigidly coupled to the cradle and supported in a groove, and
a spring configured to bias the spherical structure toward the groove.

3. The system of clause 2, wherein the spherical structure is configured to rotate based on the second adjustment mechanism adjusting the first adjustment mechanism.

4. The system of clause 2, wherein the spring comprises a leaf spring.

5. The system of clause 1, wherein the first portion of the alignment mechanism is disposed in a vacuum environment and the second portion is disposed outside of the vacuum environment.

6. The system of clause 1, wherein the second adjustment mechanism comprises:
a base rigidly coupled to the nozzle;
a mounting plate coupled to a frame of the system and disposed on the base;
a pad rigidly coupled to the mounting plate;
an intermediate structure rigidly coupled to the base and configured to be coupled to the pad; and
locking devices configured to lock the base to the mounting plate.

7. The system of clause 6, wherein the base is moveable with respect to the mounting plate.

8. The system of clause 7, wherein the intermediate structure is further configured to move the base with respect to the mounting plate.

9. The system of clause 6, wherein the first adjustment mechanism comprises:
a cradle configured to hold the nozzle;
at least one clamp configured to affix the nozzle to the cradle; and
a spherical bearing, comprising:
a spherical structure rigidly coupled to the cradle and supported in a groove, and
a spring configured to bias the spherical structure toward the groove, and
wherein the base of the second adjustment mechanism is configured to rotate the spherical structure of the first adjustment mechanism based on the second adjustment mechanism adjusting the first adjustment mechanism.

10. The system of clause 6, wherein the locking devices are further configured to lock and unlock a position of the second adjustment mechanism.

11. The system of clause 1, wherein the second adjustment mechanism comprises a plurality of adjustment members configured to adjust the second adjustment mechanism in orthogonal directions to adjust the position of the nozzle.

12. The system of clause 11, wherein the plurality of adjustment members comprises a corresponding plurality of motorized piezo actuators configured to actuate the plurality of adjustment members to steer the droplet stream.

13. The system of clause 1, wherein the first and second adjustment mechanisms are configured to adjust a position of the nozzle within a range of approximately 0.01 degrees to 1.75 degrees with respect to a plane of the alignment mechanism.

14. The system of clause 1, wherein the first and second adjustment mechanisms are configured to adjust a position of the nozzle within a range of about 0.01 degrees to 1.75 degrees with respect to each of a vertical plane of the alignment mechanism and a horizontal plane of the alignment mechanism.

15. The system of clause 1, further comprising a shielding structure having an aperture disposed at an end of the nozzle through which the droplets travel.

16. The system of clause 1, wherein the alignment mechanism is formed of a coated metal.

17. The system of clause 1, wherein the alignment mechanism is formed of stainless steel coated with titanium nitride.

18. A method comprising:
generating droplets from a nozzle of a droplet generation device, the nozzle coupled to a first portion of an alignment mechanism;
transmitting the droplets toward a target region along a droplet stream;
determining a position of the droplet stream with respect to the target region; and
adjusting, based on the determining, a position of the nozzle through an interaction of the first portion of the alignment mechanism and a second portion of the alignment mechanism, the second portion coupled to an outer surface of the droplet generation device.

19. The method of clause 18, wherein:
the first portion of the alignment mechanism is disposed in a vacuum environment inside the droplet generation device; and
the adjusting of the position of the nozzle is performed by adjusting the second portion outside of the vacuum environment.

20. The method of clause 18, wherein the adjusting comprises:
rotating first, second, third, and/or fourth adjustment members of the second portion to adjust an intermediate structure of the second portion in corresponding first, second, third, and/or fourth directions.

21. A method comprising:
generating droplets from a nozzle of a droplet generation device, the nozzle coupled to a first portion of an alignment mechanism;
transmitting the droplets toward a target region along a droplet stream;
determining a position of the droplet stream with respect to the target region; and
adjusting, based on the determining, a position of the nozzle through an interaction of the first portion of the alignment mechanism and a second portion of the alignment mechanism, the second portion coupled to an outer surface of the droplet generation device, wherein the adjusting comprises:
rotating first, second, third, and/or fourth adjustment members of the second portion to adjust an intermediate structure of the second portion in corresponding first, second, third, and/or fourth directions and wherein the rotating of the first, second, third and/or fourth adjustment members is performed using a corresponding first, second, third, and/or fourth piezo actuators.

22. The method of clause 20, wherein the adjusting of the intermediate structure of the second portion results in a proportional adjustment of the first portion.

23. The method of clause 20, wherein the adjusting of the intermediate structure produces a corresponding adjusting of a direction of the nozzle within a range of about 0.01 degrees to 1.75 degrees with respect to a plane of the first portion of the alignment mechanism.

24. The method of clause 18, further comprising:
locking the second portion of the alignment mechanism into a fixed position through tightening locking devices extending through the second portion.

25. The method of clause 18, further comprising forming the first portion using:
a cradle configured to hold the nozzle;
at least one clamp configured to affix the nozzle to the cradle; and
a spherical bearing, comprising:
a spherical structure rigidly coupled to the cradle and supported in a groove, and
a spring configured to bias the spherical structure toward the groove,
wherein the adjusting of the position of the nozzle comprises rotating the spherical structure by moving the second adjustment mechanism to move the first adjustment mechanism.

26. The method of clause 18, further comprising transmitting the droplets from the nozzle through an aperture towards the target region.

27. A system, comprising:
a first portion of an alignment mechanism coupled to a nozzle and disposed within a droplet generation device;
a second portion of the alignment mechanism coupled to an outside surface of the droplet generation device,
wherein the second portion comprises a second adjustment mechanism configured to adjust a first adjustment mechanism of the first portion in order to adjust a position of the nozzle and align a path of a droplet stream with respect to a target region,
wherein the first adjustment mechanism comprises:
a cradle configured to hold the nozzle,
at least one clamp configured to affix the nozzle to the cradle,
a spherical bearing, comprising:
a spherical structure rigidly coupled to the cradle and supported in a groove, and
a leaf spring configured to bias the spherical structure toward the groove, and
wherein the second adjustment mechanism comprises:
a base rigidly coupled to the nozzle;
a mounting plate coupled to a frame of the system and disposed on the base;
a pad rigidly coupled to the mounting plate; and
an intermediate structure rigidly coupled to the base and configured to be coupled to the pad;
wherein the base is movable with respect to the mounting plate, the intermediate structure is further configured to move the base with respect to the mounting plate, the base is configured to rotate the spherical structure based on adjusting the intermediate structure, and the adjusting of the intermediate structure results in a proportional adjustment of the first portion.

28. The system of clause 27, further comprising locking devices configured to lock the base to the mounting plate.

29. The system of clause 27, wherein the second adjustment mechanism comprises a plurality of motorized piezo actuator adjustment members configured to adjust the second adjustment mechanism in orthogonal directions to steer the path of the droplet stream.

The above described implementations and other implementations are within the scope of the following claims.

1-29. (canceled)

30. A system comprising:
a first portion of an alignment mechanism coupled to a nozzle and disposed within a droplet generation device, the first portion comprising a first adjustment mechanism; and
a second portion of the alignment mechanism coupled to an outside surface of the droplet generation device, the second portion comprising a second adjustment mechanism,
wherein the second adjustment mechanism is configured to adjust the first adjustment mechanism to adjust a position of the nozzle and align a path of a droplet stream with respect to a target region.

31. The system of claim 30, wherein the first adjustment mechanism comprises:
a cradle configured to hold the nozzle;
at least one clamp configured to affix the nozzle to the cradle; and
a spherical bearing, comprising:
a spherical structure rigidly coupled to the cradle and supported in a groove, and
a spring configured to bias the spherical structure toward the groove.

32. The system of claim 31, wherein the spherical structure is configured to rotate based on the second adjustment mechanism adjusting the first adjustment mechanism.

33. The system of claim 30, wherein the first portion of the alignment mechanism is disposed in a vacuum environment and the second portion is disposed outside of the vacuum environment.

34. The system of claim 30, wherein the second adjustment mechanism comprises:
a base rigidly coupled to the nozzle;
a mounting plate coupled to a frame of the system and disposed on the base;
a pad rigidly coupled to the mounting plate;
an intermediate structure rigidly coupled to the base and configured to be coupled to the pad; and
locking devices configured to lock the base to the mounting plate.

35. The system of claim 34, wherein the base is configured to be moveable with respect to the mounting plate.

36. The system of claim 34, wherein the first adjustment mechanism comprises:
a cradle configured to hold the nozzle;
at least one clamp configured to affix the nozzle to the cradle; and
a spherical bearing, comprising:
a spherical structure rigidly coupled to the cradle and supported in a groove, and
a spring configured to bias the spherical structure toward the groove, and
wherein the base of the second adjustment mechanism is configured to rotate the spherical structure of the first adjustment mechanism based on the second adjustment mechanism adjusting the first adjustment mechanism.

37. The system of claim 30, wherein the second adjustment mechanism comprises a plurality of adjustment members configured to adjust the second adjustment mechanism in orthogonal directions to adjust the position of the nozzle.

38. The system of claim 30, wherein the first and second adjustment mechanisms are configured to adjust a position of the nozzle within a range of approximately 0.01 degrees to approximately 1.75 degrees with respect to a plane of the alignment mechanism.

39. A method comprising:
generating droplets from a nozzle of a droplet generation device, the nozzle coupled to a first portion of an alignment mechanism;
transmitting the droplets toward a target region along a droplet stream;
determining a position of the droplet stream with respect to the target region; and
adjusting, based on the determining, a position of the nozzle through an interaction of the first portion of the alignment mechanism and a second portion of the alignment mechanism, the second portion coupled to an outer surface of the droplet generation device.

40. The method of claim 39, wherein:
the first portion of the alignment mechanism is disposed in a vacuum environment inside the droplet generation device; and
the adjusting of the position of the nozzle is performed by adjusting the second portion outside of the vacuum environment.

41. The method of claim 39, wherein the adjusting comprises:
rotating first, second, third, and/or fourth adjustment members of the second portion to adjust an intermediate structure of the second portion in corresponding first, second, third, and/or fourth directions.

42. The method of claim 41, wherein the adjusting of the intermediate structure of the second portion results in a proportional adjustment of the first portion.

43. The method of claim 41, wherein the adjusting of the intermediate structure produces a corresponding adjusting of a direction of the nozzle within a range of about 0.01 degrees to about 1.75 degrees with respect to a plane of the first portion of the alignment mechanism.

44. The method of claim 39, further comprising:
locking the second portion of the alignment mechanism into a fixed position through tightening locking devices extending through the second portion.

45. The method of claim 39, further comprising forming the first portion using:
a cradle configured to hold the nozzle;
at least one clamp configured to affix the nozzle to the cradle; and
a spherical bearing, comprising:
a spherical structure rigidly coupled to the cradle and supported in a groove, and
a spring configured to bias the spherical structure toward the groove,
wherein the adjusting of the position of the nozzle comprises rotating the spherical structure by moving the second adjustment mechanism to move the first adjustment mechanism.

46. A system, comprising:
a first portion of an alignment mechanism coupled to a nozzle and disposed within a droplet generation device, the first portion comprising a first adjustment mechanism;
a second portion of the alignment mechanism coupled to an outside surface of the droplet generation device, the second portion comprising a second adjustment mechanism
wherein the second adjustment mechanism is configured to adjust the first adjustment mechanism in order to adjust a position of the nozzle and align a path of a droplet stream with respect to a target region,
wherein the first adjustment mechanism comprises:
a cradle configured to hold the nozzle,
at least one clamp configured to affix the nozzle to the cradle,
a spherical bearing, comprising:
a spherical structure rigidly coupled to the cradle and supported in a groove, and
a leaf spring configured to bias the spherical structure toward the groove, and
wherein the second adjustment mechanism comprises:
a base rigidly coupled to the nozzle;
a mounting plate coupled to a frame of the system and disposed on the base;
a pad rigidly coupled to the mounting plate; and
an intermediate structure rigidly coupled to the base and configured to be coupled to the pad;
wherein the base is movable with respect to the mounting plate,
wherein the intermediate structure is further configured to move the base with respect to the mounting plate,
wherein the base is configured to rotate the spherical structure based on adjusting the intermediate structure, and
wherein the adjusting of the intermediate structure results in a proportional adjustment of the first portion.

47. The system of claim 46, further comprising locking devices configured to lock the base to the mounting plate.
